(19) United States
(12) Patent Application Publication
(10) Pub. No.: US 2025/0077939 A1
(43) Pub. Date: Mar. 6, 2025

(54) SYSTEMS AND METHODS FOR COMPUTING FAIRNESS METRICS IN ARTIFICIAL INTELLIGENCE AND MACHINE LEARNING MODELS

(71) Applicant: The Toronto-Dominion Bank, Toronto (CA)

(72) Inventors: Talieh Tabatabaei, Richmond Hill (CA); Rustam Vosilov, Montreal (CA)

(21) Appl. No.: 18/240,882

(22) Filed: Aug. 31, 2023

(51) Int. Cl. G06N 20/00

(52) U.S. Cl. CPC G06N 20/00

(57) ABSTRACT

Systems and methods for assessing machine learning model fairness are provided. A graphical user interface (GUI) is rendered in a web browser. Input data from the web browser is obtained. A first input produced by a first GUI control is received to identify a prediction column in the input data. A second input produced by a second GUI control is received to identify a ground truth column. A third input produced by a third GUI control is received to identify a sensitive attribute column. A plurality of groups within a plurality of sensitive attribute values in the sensitive attribute column are automatically displayed. The system processes the input data based on the prediction column, the ground truth column and the sensitive attribute column to generate one or more algorithmic fairness analysis, which are used to display a visual report.

### TECHNICAL FIELD

The disclosed exemplary embodiments relate to computer-implemented systems and methods for computing fairness metrics in artificial intelligence and machine learning models and, in particular, to a software tool that includes a graphical user interface for computing one or more algorithmic fairness analysis.

### BACKGROUND

Machine learning (ML) and artificial intelligence (AI) models are used to make predictions, including predictions about people and their activities. The models can be used for process automation, ranking or scoring, detection of malicious activity, etc. However, in some cases AI or ML models (or both) exhibit unwanted bias across sensitive groups (e.g., gender, age, ethnicity, etc.). Therefore, it may be desirable to measure the algorithmic bias of these models. More generally, the term “AI/ML models” herein refers to AI models or ML models, or computational models that fall into both categories.

Measuring and quantifying the algorithmic bias of AI/ML models is non-trivial. AI/ML models are inherently non-linear and complex with a “black box” nature. AI/ML models also have a high number of input variables. There are also many different types of AI/ML models, which makes the analysis process non-standardized. Further, existing software tools often involve many additional manual data processing steps.

### SUMMARY

The following summary is intended to introduce the reader to various aspects of the detailed description, but not to define or delimit any invention.

In at least one broad aspect, there is an apparatus for assessing machine learning model fairness. The apparatus includes one or more processors configured to: provide instructions for rendering a graphical user interface (GUI) in a web browser; obtain input data from the web browser; receive a first input produced by a first GUI control of the GUI to identify prediction column in the input data, the prediction column comprising a plurality of prediction values corresponding to a plurality of individuals; receive a second input produced by a second GUI control of the GUI to identify a ground truth column, the ground truth column comprising a plurality of ground truth values corresponding to the plurality of individuals; receive a third input produced by a third GUI control of the GUI to identify one or more sensitive attribute columns, wherein each of the sensitive attribute columns comprises a plurality of sensitive attribute values corresponding to the plurality of individuals; automatically display in association with the third GUI control a plurality of groups within the plurality of sensitive attribute values; process the input data based on the prediction column, the ground truth column and the one or more sensitive attribute columns to generate one or more algorithmic fairness analysis; and, display one or more visual reports associated with the one or more algorithmic fairness analysis.

In some cases, the one or more processors are further configured to receive a fourth input produced by a fourth GUI control of the GUI to identify a reference group from the plurality of groups.

In some cases, the one or more processors are further configured to receive a merging input produced by the GUI to merge at least two groups in the plurality of groups, and responsive to the merging input, cause the GUI to display a merged group in place of the at least two groups.

In some cases, the plurality of groups is displayed in an editable field in the GUI, and the merging input is produced using the editable field.

In some cases, the merging input comprises a first bracket and a second bracket inputted around the at least two groups.

In some cases, the one or more processors are further configured to receive a fifth input produced by a fifth GUI control to identify a top percentile.

In some cases, the one or more processors are further configured to receive a sixth input produced by a sixth GUI control to identify a bottom percentile.

In some cases, the one or more algorithmic fairness analysis is selected from the group consisting of: a disparate impact report, a calibration curves report, an average predicted score report, and a performance metrics report.

In some cases, the input data is a comma-separated value file.

In another broad aspect, a method is provided for assessing machine learning model fairness. The method is executed in a computing environment comprising one or more processors and memory. The method comprises: providing instructions for rendering a graphical user interface (GUI) in a web browser; obtaining input data from the web browser; receiving a first input produced by a first GUI control of the GUI to identify prediction column in the input data, the prediction column comprising a plurality of prediction values corresponding to a plurality of individuals; receiving a second input produced by a second GUI control of the GUI to identify a ground truth column, the ground truth column comprising a plurality of ground truth values corresponding to the plurality of individuals; receiving a third input produced by a third GUI control of the GUI to identify one or more sensitive attribute columns, wherein each of the sensitive attribute columns comprises a plurality of sensitive attribute values corresponding to the plurality of individuals; automatically displaying in association with the third GUI control a plurality of groups within the plurality of sensitive attribute values; processing the input data based on the prediction column, the ground truth column and the one or more sensitive attribute columns to generate one or more algorithmic fairness analysis; and, displaying one or more visual reports associated with the one or more algorithmic fairness analysis.

In some cases, the method further comprises receiving a fourth input produced by a fourth GUI control of the GUI to identify a reference group from the plurality of groups.

In some cases, the method further comprises receiving a merging input produced by the GUI to merge at least two groups in the plurality of groups, and responsive to the merging input, causing the GUI to display a merged group in place of the at least two groups.

In some cases, the plurality of groups is displayed in an editable field in the GUI, and the merging input is produced using the editable field.

In some cases, the merging input comprises a first bracket and a second bracket inputted around the at least two groups.

In some cases, the method further comprises receiving a fifth input produced by a fifth GUI control to identify a top percentile.

In some cases, the method further comprises receiving a sixth input produced by a sixth GUI control to identify a bottom percentile.

In some cases, the one or more algorithmic fairness analysis is selected from a group consisting of: a disparate impact report, a calibration curves report, an average predicted score report, and a performance metrics report.

In some cases, the input data is a comma-separated value file.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for computing fairness metrics in AI/ML models in accordance with at least some embodiments;

FIG. 1B is a schematic block diagram of a server of FIG. 1A in accordance with at least some embodiments;

FIG. 2 is a block diagram of a computer in accordance with at least some embodiments;

FIGS. 3A, 3B, 3C, and 3D are graphical user interface examples of a software tool for computing fairness metrics in AI/ML models in accordance with at least some embodiments; and

FIG. 4 is a flowchart diagram of an example method of computing fairness metrics on a computing device in accordance with at least some embodiments.

### DETAILED DESCRIPTION

In some cases, a software tool is provided herein for comprehensive fairness and bias assessment for AI/ML models and reporting. A user can access the software tool, which includes a graphical user interface (GUI) for uploading input data that has been generated from the AI/ML model. The tool is configured to set analysis parameters and generate one or more algorithmic bias analysis and reports.

In some cases, the software tool is web-based tool accessible via a web browser on a client device. In other words, the GUI of the web-based tool is displayed and operated on the web browser. In some other cases, the software tool is a dedicated application on a client device that accesses a server system.

In some cases, the input data is a data file. In some cases, the input data is a CSV (comma separated values) file. Input data that have alternative types of data file formats can be used with the web-based tool in some other cases. Examples of other types of data file formats include Javascript Object Notation (JSON) and Python Pickle (PKL). Other types of data file formats that store data in rows and columns, such as in a spreadsheet or chart may also be used with the web-based tool provided herein.

In some cases, the input data includes several columns. These columns include one or more columns for the predicted data that are outputted from a given AI/ML model, one or more columns for ground truth data (also called label data) corresponding to the predicted data, and one or more columns for sensitive attributes (e.g., gender, age, ethnicity, etc.). In some cases, the one or more sensitive attributes are not inputted (i.e., considered) by the AI/ML model and are added to the data input file to identify if there is unintended bias. In some other cases, the one or more sensitive attributes is/are inputted into the AI/ML model.

In some cases, the software tool automatically identifies groups of data within the data input file. In some other cases, either in addition or in the alternative, the software tool provides a GUI control that allows a user to identify groups of data within the data input file. For example, if a sensitive attribute includes age of people, then the data can be grouped into different ranges of age. For example, if a sensitive attribute includes the location of people, then the data can be grouped into different locations. In some cases, the groups can be merged in the GUI to form a larger merged group. Other settings, such as a control group (also herein called a reference group), a top percentile and a bottom percentile, can be selected using the GUI.

In some cases, the software tool automatically uses the categorized data from the input data and the selected settings, to generate reports comparing the groups. The reports can be viewed in the GUI or can be outputted in a document.

In some cases, the software tool processes the input data (e.g., a CSV file or some other data file type) and identifies the headers columns of the input data.

In some cases, the GUI of the software tool includes a control that facilitates the user to identify a prediction column from the input data. The prediction column includes predicted scores associated with a set of users.

In some cases, the GUI of the software tool includes a control that facilitates the user to identify a ground truth column from the input data. The ground truth column includes actual scores associated with the same set of users.

In some cases, the GUI of the software tool includes a control that facilitates the user to identify a sensitive attribute column from the input data. For example, if the input data includes column for age, a column for gender, and a column for location, the user can use this control to select from age, gender, or location. The data of these different types of sensitive attributes is associated with the same set of users. In some cases, another GUI control is used to identify groups within the data of the sensitive attribute column(s), or modify groups that were automatically identified within the data of the sensitive attributes column(s).

In some cases of a specific GUI implementation, the control, which facilitates the user to identify a sensitive attribute column, facilitates the user to merge groups to create a larger merged group. The ability to merge groups is helpful to collapse small groups into a larger group. Merging is done, for example, by displaying at least two groups in the control, and receiving brackets that are inputted by the user around the two groups, and then merging the two groups into a merged group.

Other controls in the GUI include setting a reference group or control group, setting one or more top percentiles, and setting one or more bottom percentiles.

In some cases, the software tool uses the inputs from the controls of the GUI to produce one or more reports. The reports include: distribution of users across the different groups associated with a selected sensitive attribute, calibration curves, AU-ROC (area under Receiver Operator Characteristic) plots, PR-AUC (Precision-Recall area under curve) plots, KS test results, disparate impact comparisons, etc.

In some cases, the front end of the software tool is implemented with a Python-based library, such as Flask, for developing web-based apps. In some cases, a background library for the software tool includes the calculations used for the analysis.

In some cases, the software tool saves data sets in memory temporarily to provide computational efficiency. Data is deleted from memory periodically to improve or maintain computational efficiency.

In some cases, the software tool is automated and standardized. In other words, a user can quickly initiate measurement of algorithmic bias with few steps. Further, in some cases, the software tool can accept data outputted from any AI/ML model. In other words, the software tool is AI/ML model agnostic.

In an example aspect, the software tool also reduces risk of manual errors/inconsistencies. It also reduces the number of user steps.

In some cases, the software tool covers different fairness definitions and metrics.

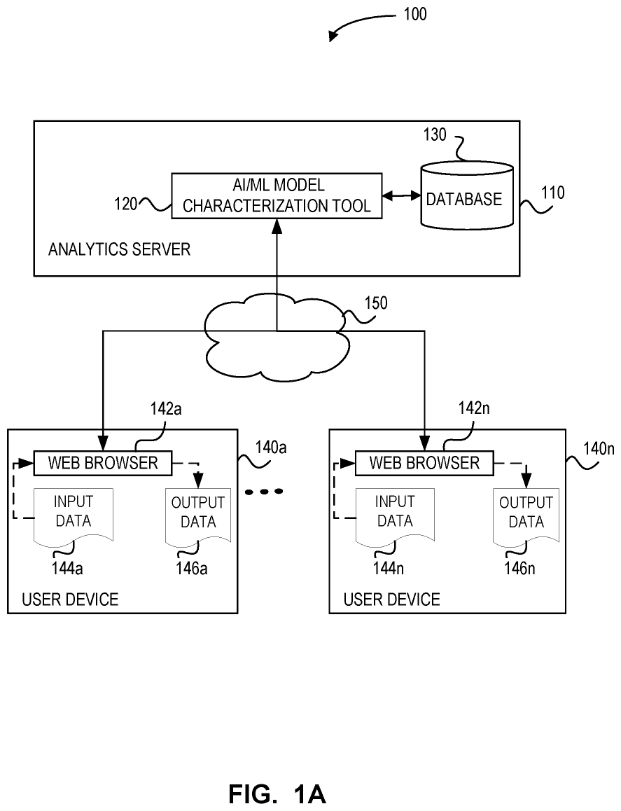

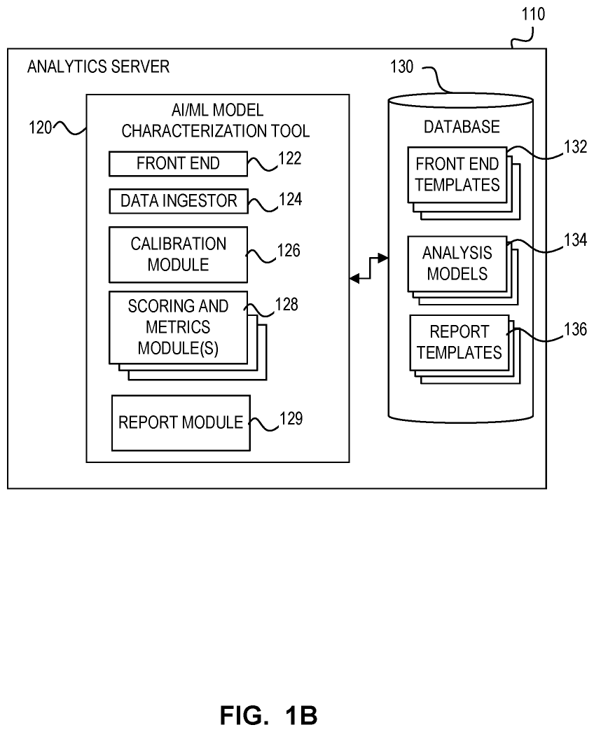

Referring now to FIG. 1A, there is illustrated a block diagram of an example computing system, in accordance with at least some embodiments. Computing system 100 has an analytics server 110 operatively coupled to one or more user devices 140a, 140n. In some cases, the analytics server 110 and the user devices 140a, 140n data communicate with each other over a data network 150. In some cases, the data network 150 is a private data network, such as an Intranet. In some other case, the data network 150 is the Internet.

The analytics server 110 includes an AI/ML model characterization (AMC) tool 120 and a database 130 that is accessible by the AMC tool 120. In some cases, AMC tool 120 is a software tool that generates a GUI that is rendered on a web browser 142 on a user device 140. In some other cases, the AMC tool 120 is a software tool that sends and receives data via a dedicated software application (“app”) that is stored and run locally on the user device 140. In some cases, the server resides in a cloud computing system. In some cases, the cloud computing system and the analytics server 110 includes several processing nodes.

In some cases, the user device 140a stores and locally runs a web browser 142a, which is operable to connect with the AMC tool 120. Input data 144a (e.g., in the form of a CSV file or other data file format), which includes rows corresponding to different people and columns associated with different attributes of the people, is inputted into the web browser and processed, based on certain settings, by the AMC tool 120. The input data, for example, is outputted by a given AI/ML model and the AMC tool 120 processes the input data to characterize metrics related to fairness and data bias. The AMC tool 120 sends the results, which are metrics related to fairness and data bias, to the web browser 142a, which displays the results as output data 146a. In some cases, this output data 146a is downloaded onto the user device as a data file (e.g., a document file, a spreadsheet file, or a presentation file).

One or more other user devices, such as the user device 140n, can access the AMC tool 120 at the same time as the user device 140a. For example, the user device 140n also includes a web browser 142n, input data 144n (e.g., outputted by a different given AI/ML model), and output data 146n that includes results computed by the AMC tool 120 based on the input data 144n.

In some cases, the AMC tool 120 is operable to process data processing requests from multiple user devices 140a, 140n at the same time. In some other cases, the AMC tool 120 is operable to store data processing requests from multiple user devices 140a, 140n into a data processing request queue, and process multiple data requests from the data processing queue at the same time. Alternatively, the AMC tool 120 processes one data request at a time from the data processing queue.

In some other cases, instead of a web browser 142, the user devices store and run a dedicated AMC software application that data communicates with the AMC tool 120.

Referring now to FIG. 1B, examples of data components in the AMC tool 120 and in the database 130 are shown.

In some cases, the AMC tool 120 includes a front end 122, a data ingestor 124, a calibration module 126, one or more scoring and metric modules 128, and a report module 129.

In an example aspect, the front end 122 generates instructions for presenting and operating the GUI, which is displayable and operable at the user device 140. The front end 122 is configured to access front end templates 132 in the database 130, including GUI control widgets, graphical elements, and other content and functional code used in the GUI displayed at the user device 140.

In an example aspect, the data ingestor 124 is configured to ingest input data provided by a user device. In some cases, the data ingestor automatically identifies the rows and columns, including the headings of each column.

In an example aspect, the calibration module 126 is configured to compute one or more metrics to determine if the input data or the scoring and metric module 128 (or both) are calibrated. In an example aspect, a classifier satisfies this definition if for any predicted probability score S, subjects in both protected and unprotected groups have equal probability to truly belong to the positive class. In an example aspect, calibration means that outcomes should be independent of protected attributes conditional on risk score. In another example aspect, calibration ensures that risk scores S mean the same thing for all protected groups. In a specific example, when S has only two values this condition is recognized as positive/negative predictive parity. For an example scenario, in the loan context, calibration means that among applicants with a given risk score, the proportion who would default if given the loan is the same across different groups. In some cases, the calibration module 126 is configured to access data from the analysis models 134, which can include different computations and parameters used in determining calibration metrics. In an example aspect, the calibration module 126 can compute calibration curves for different groups identified in the input data. In another example aspect, a calibration computation performed by the calibration module 126 is an example of an algorithmic fairness analysis.

In an example aspect, the one or more scoring and metrics modules 128 execute scoring and metrics computations to assess the fairness or the bias of a given AI/ML model, based on the input data that the AMC tool 120 has ingested. In other words, the scoring and metrics module(s) 128 process the input data to compute one or more algorithmic fairness analysis.

Some examples of different metrics computed by the AMC tool 120 for fairness for decisions include: Equal True Positive Rate (TPR), Equal False Negative Rate (FNR), Equal False Positive Rate (FPR), Equal True Negative Rate (TNR), Equal Positive Predictive Value (PPV), Equal False Discovery Rate (FDR), Equal False Omission Rate (FOR), Equal Negative Predictive Value (NPV), Equalized Odds, Statistical Parity, Conditional Statistical Parity, and Overall Accuracy Equality.

Some examples of different fairness metrics for scores computed by the AMC tool 120 include Balance for Positive Class, Balance for Negative Class, Calibration, and Area Under the Curve (AUC) Parity. In an example aspect, AUC parity refers to the area under the Receiver Operating Characteristic (ROC) curve that should be the same across different data groups.

Some examples of the individual fairness metrics computed by the AMC tool 120 include Fairness Through Unawareness (FTU) and Individual Fairness.

Some examples of causality metrics computed by the ACM tool 120 include Individual Counterfactual Fairness, Counterfactual Parity, and Conditional Counterfactual Parity.

In some cases, the one or more scoring and metrics modules 128 access the analysis modules 134 in the database 130 to obtain the computations and parameters to execute one or more of the above-noted metrics, which are examples of algorithmic fairness analysis.

In an example aspect, the report module 129 generates reports that are displayed as output data via the front end 122. In some cases, either in addition or in the alternative, the report module 129 generates a data file, which includes the output data, that is sent to the user device 140. For example, the user device 140 is operable to locally download the data file. In some cases, the report module 129 automatically obtains one or more report templates 136 from the database 130 to automatically generate and compile one or more reports.

In an example aspect, the report module 129 outputs one or more visual reports associated with the one or more algorithmic fairness analysis. Examples of visual reports include a disparate impact report, a calibration curves report, an average predicted score report, and a performance metrics report.

In some cases, the analytics server 110 is implemented as one or more virtual machines in a cloud computing environment that includes a computing cluster. In some cases, the computing cluster includes a file system for storing training data and the data in the database 130. In some cases, the file system is a distributed file system such as the Hadoop Distributed File System (HDFS). HDFS can be used to implement the database 130, each of which may contain one or more tables, and which may be partitioned temporally or otherwise.

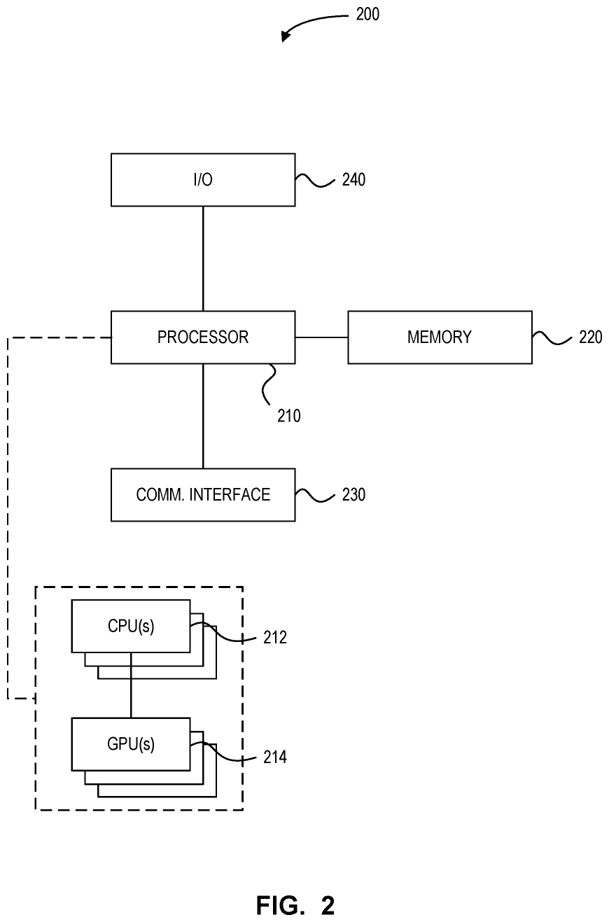

Referring now to FIG. 2, there is illustrated a simplified block diagram of a computer in accordance with at least some embodiments. Computer 200 is an example implementation of a computer such as the analytics server 110 and the user device 140 of FIG. 1A. Computer 200 has at least one processor 210 operatively coupled to at least one memory 220, at least one communications interface 230 (also herein called a network interface), and at least one input/output device 240. For a user device 140, examples of input/output devices include a display screen, a pointer selection controller (e.g., a mouse or a touch screen, or both), and a keyboard (e.g., a physical keyboard or a touch screen that includes digital keyboard functionality, or both).

The at least one memory 220 includes a volatile memory that stores instructions executed or executable by processor 210, and input and output data used or generated during execution of the instructions. Memory 220 may also include non-volatile memory used to store input and/or output data—e.g., within a database-along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the prediction processor 166 executes machine learning computations on CPU and GPU hardware, such as the system of CPUs 212 and GPUs 214.

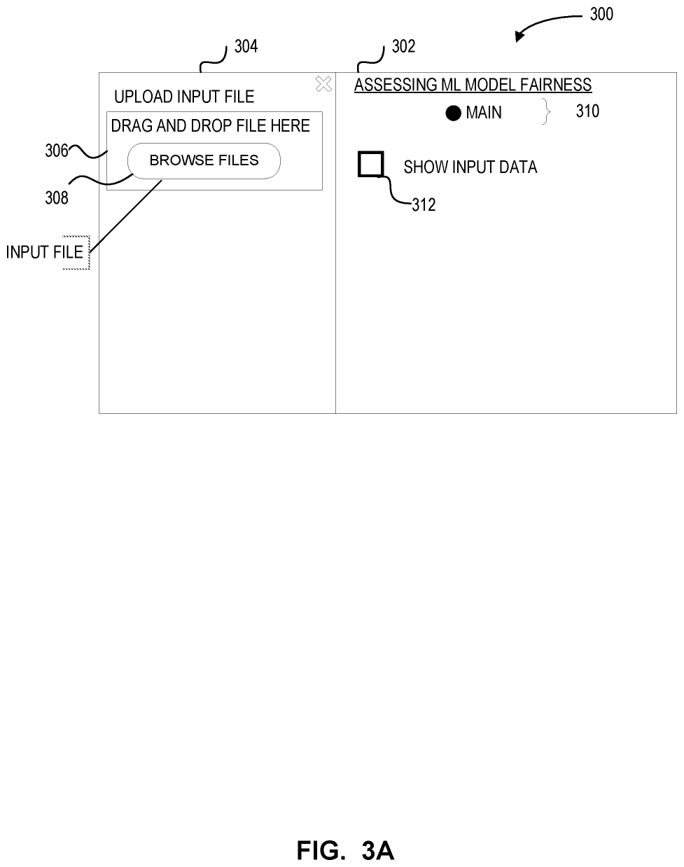

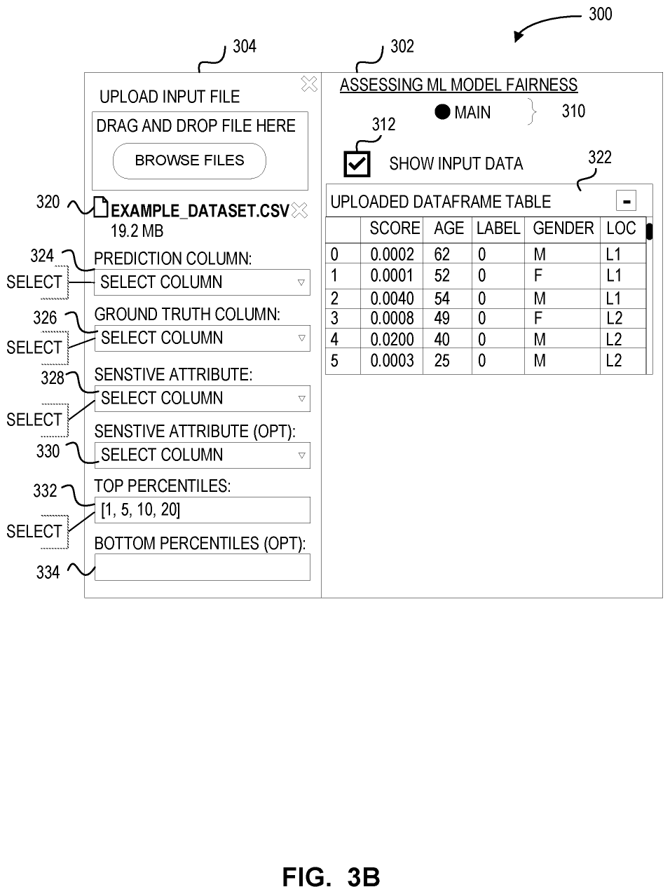

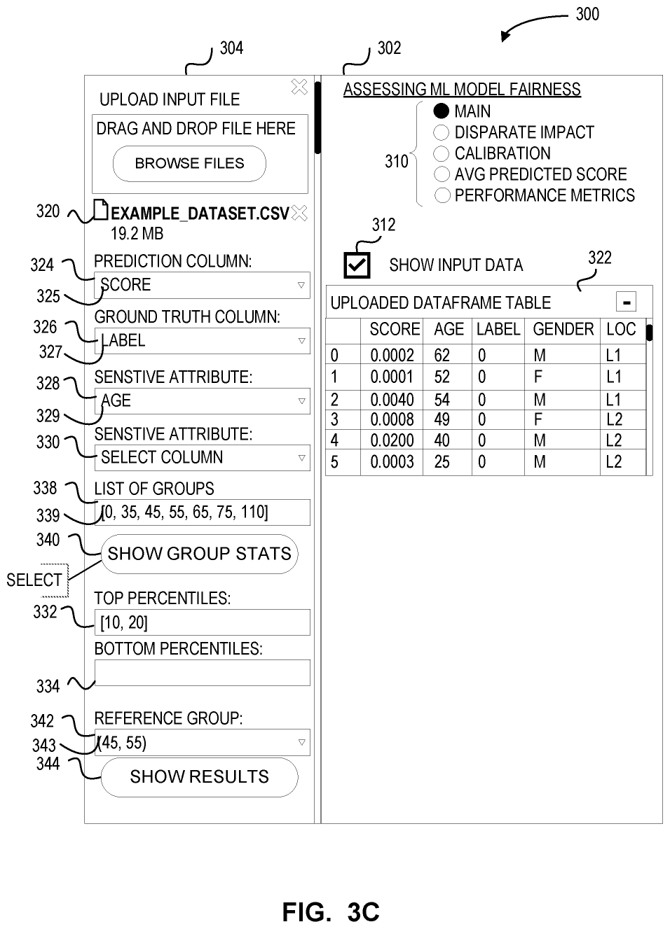

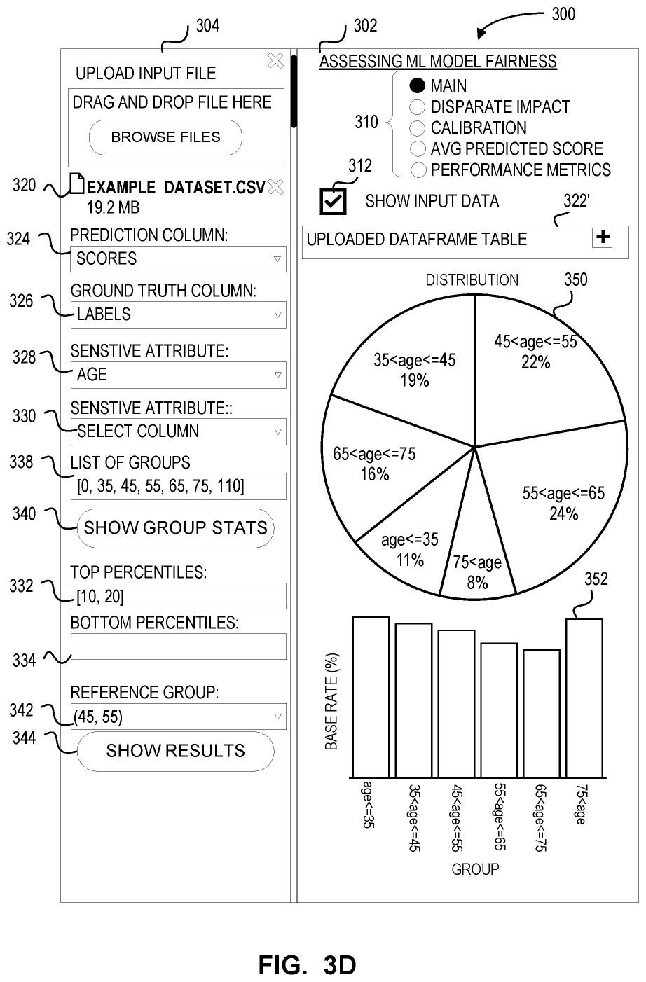

FIGS. 3A to 3D show a sequence of example stages of a GUI 300 that are provided by the AMC tool 120 and are displayed by the web browser 142 at a user device 140. In an example aspect, the AMC tool 120 provides instructions for rendering the GUI 300 in the web browser 142 of the user device 140.

Referring now to FIG. 3A, an example GUI 300 is shown that, in some cases, the state of this GUI is initially displayed at or near the beginning of assessing a given AI/ML model. The GUI 300 includes an output data section 302 for showing results (e.g., output data) and an input data section 304 for showing controls related to the input data.

The input data section 304 includes one or more controls 306, 308 that are operable by a user to upload input data (e.g., also called an input file). In some cases, a control 306 is provided and is operable for a draft and drop user functionality, in which a user can drag and drop an input data file into the control 306, thereby initiating an upload of the input data file to the AMC tool 120. In some cases, a control 308 is provided and is operable by a user to launch a local file browser on the user device to search for an input data file to upload to the AMC tool 120. One or both of these controls 306, 308 can be used by the user to obtain input data using the web browser.

The output data section 302 includes one or more controls 310 for displaying the type of output data. At this stage of the process, the GUI 300 shows one control indicating the “main” type of output data, which is initially selected as default. An option control 312 is operable to be selected to show input data.

Using either control 306 or control 308, the user uploads input data to the AMC tool 120 via the web browser. In other words, the AMC tool 120 obtains the input data from the web browser.

Referring now to FIG. 3B, after the input data file has been uploaded, an indicator of the input data 320 is displayed in the GUI 300. In some cases, the indicator of the input data 320 includes an icon, a name of the input data file (e.g., “EXAMPLE_DATASET.CSV”) and a data size.

The input data 320 includes rows and columns. In some cases, the rows represent individuals (e.g., user accounts, people, etc.). The columns include a prediction column, a ground truth column, and one or more sensitive attributes columns. The prediction column includes a plurality of prediction values corresponding to a plurality of individuals. The ground truth column includes a plurality of ground truth values corresponding to the plurality of individuals. Each of the sensitive attribute columns include a plurality of sensitive attribute values corresponding to the plurality of individuals.

The AMC tool 120 processes the input data 320 to automatically identify the rows, the columns and the heading of each column, and generates a dataframe table 322 that is rendered in the GUI 300, as per FIG. 3B. The dataframe table 322 displays the columns, the column headers, the rows and the data values associated with each column. For example, the dataframe table 322 displays a “SCORE” column header and the associated data values corresponding to the individuals in the different rows, an “AGE” column header and the associated data values corresponding to the individuals in the different rows, a “LABEL” column header and the associated data values corresponding to the individuals in the different rows, a “GENDER” column header and the associated data values corresponding to the individuals in the different rows, and a “LOC” column header and the associated data values corresponding to the individuals in the different rows.

The display of the dataframe table 322 in the GUI 300 is controllable using the GUI control 312, which can cause the dataframe table 322 to be displayed or hidden. In some cases, after the AMC tool 120 obtains the input data 320, the AMC tool 120 processes the input data 320 and generates and sends instructions to the web browser 142 that cause the web browser 142 to display the dataframe table 322.

Using the GUI controls in the GUI 300, a user can identify which of these columns in the input data are a prediction column, a ground truth column, and a sensitive attribute column.

A first GUI control 324, which is labelled in the GUI 300 as “PREDICTION COLUMN”, is operable to receive a first input to identify a prediction column in the input data. A second GUI control 326, which is labelled in the GUI 300 as “GROUND TRUTH COLUMN”, is operable to receive a second input to identify a ground truth column in the input data. A third GUI control 328, which is labelled in the GUI 300 as “SENSITIVE ATTRIBUTE”, is operable to receive a third input to identify a sensitive attribute column in the input data.

In some cases, there may be multiple instances of the same type of the third GUI control to identify multiple sensitive attribute columns. For example, a second instance of the third GUI control 330 is operable to identify a second sensitive attribute column in the input data.

The user provides a first input 325 into the first GUI control 324 of the GUI to identify a prediction column in the input data, and this first input is received by the AMC tool 120. For example, the first GUI control 324 is a drop-down list that shows the identified column headers extracted from the input data, which are operable to be selected. In this example, the user selects “SCORE” as the prediction column.

Similarly, the user provides a second input 327 into the second GUI control 326 of the GUI to identify a ground truth column in the input data, and this second input is received by the AMC tool 120. In this example, the user selects “LABEL” from the drop-down list in the second GUI control as the ground truth column.

The user provides a third input 329 into the third GUI control 328 of the GUI to identify a sensitive attribute column in the input data, and this third input is received by the AMC tool 120. In this example, the user selects “AGE” from the drop-down list in the third GUI control as the sensitive attribute column.

These selections are shown in FIG. 3C. After the AMC tool 120 detects these inputs, the AMC tool 120 automatically causes the GUI 300 to display in association with the third GUI control 328 a plurality of groups 339 within the plurality of sensitive attribute values. In this example, the sensitive attribute is age, and the groups are ranges of ranges (e.g., groups characterized by ages 35 and under, ages 35 to 45, ages 45 to 55, ages 65 to 75, and ages 75 and older). In this way, the individuals are grouped according to the corresponding identified sensitive attribute values.

In some cases, the groups are automatically identified by the AMC tool 120. In some cases, the AMC tool 120 detects that the values are numbers with a minimum value and a maximum value in the data set, and the AMC tool splits the data set into n number of equal-sized groups that span the minimum value and the maximum value.

In some other cases, the AMC tool 120 detects that the column header of the sensitive attribute relates to age (e.g., using text identification of the terms “age”, “ages”, “birthday”, “date of birth”, “DOB”, and the like), and automatically provides age groupings for display in the GUI 300.

In some other cases, the AMC tool 120 detects that the column header of the sensitive attribute relates to location (e.g., using text identification of the terms “location”, “city”, “country”, “state”, “province”, and the like), and automatically provides location groupings for display in the GUI 300. For example, each different location in the data set forms a group. For example, if the data set of sensitive attributes includes five different states (or provinces), then the GUI 300 automatically displays a list of these five different states (or provinces).

In some other cases, the AMC tool 120 detects that the column header of the sensitive attribute relates to gender (e.g., using text identification of the terms “gender”, “sex”, “M/F”, “male/female”, and the like), and automatically provides two groupings (e.g., M and F, or male and female) for display in the GUI 300.

It will be appreciated that the plurality of groups will depend on the type of selected sensitive attribute and the corresponding values.

In some cases, the plurality of groups 339 is displayed in an editable field 338 that facilitates a user to modify the groups. For example, the user can provide a merging input using the editable field 338 in the GUI 300 to merge at least two groups in the plurality of groups. This merging input is sent to the AMC tool 120, and responsive to the merging input, it causes the GUI to display a merged group in place of the at least two groups. For example, brackets (e.g., square brackets [and] or parentheses (and)) are inserted into the editable field 338 to merge two or more groups into one group. The merging input includes inputting a first bracket and a second bracket around at least two groups. In an example scenario of age, inserting a first bracket and a second bracket around the 0 and the 45, such as [(0, 35, 45), 55, 65, 75, 110], results in merging the groups of ages under 35 and ages 35 to 45 into one group. In some other cases, alternative formats of merging inputs are used in the GUI 300 to merge two or more groups together. For example, touch screen gestures or pointer gestures may be used to select two or more groups to be merged into one group.

At this stage, the AMC tool 120 has sufficient information to process the input data based on the prediction column, the ground truth column and the one or more sensitive attribute columns to generate one or more algorithmic fairness analysis. The AMC tool 120 is configured to further compute and cause the GUI 300 to display one or more visual reports associated with the one or more algorithmic fairness analysis.

In some cases, a fourth GUI control 342 of the GUI 300 is displayed and receives a fourth input 343 to identify a reference group or control group from amongst the plurality of groups. This can be used by the AMC tool 120 as a parameter in a given algorithmic fairness analysis. In some cases, the fourth GUI control 342 is a drop-down list that lists all the groups identified in the plurality of groups. In some cases, either in alternative or in addition to the drop-down field, the fourth GUI control 342 is an editable field that allows a user to type characters specifying one or more reference groups. In this example scenario, shown in FIG. 3C, the fourth input specifies that the group between ages 45 and 55 is the reference group.

In some cases, as shown in FIG. 3B and in FIG. 3C, the GUI 300 includes a fifth GUI control 332 to identify a top percentile and a sixth GUI control 334 to identify a bottom percentile. For example, a fifth input entered into the fifth GUI control 332 includes the values 10 and 20. The AMC tool 120 uses these values as parameters when computing one or more algorithmic fairness analysis. For example, the AMC tool 120 computes an average predicted score for disparate impact analysis across all data for each age group (in the example scenario of age groups as shown in FIGS. 3B and 3C), an average predicted score for the top 10 percentile in each age group, and an average predicted score for the top 20 percentile in each age group. It will be appreciated on more top percentile parameters can be included.

In some cases, the AMC tool 120 automatically populates the fifth GUI control 332 with one or more default values, and the user can modify (e.g., add, edit, delete) these one or more default values. In some cases, the similar operation occurs for the sixth GUI control 334 in relation to one or more default values for bottom percentile values to be considered in the one or more algorithmic fairness analysis.

In the example in FIG. 3C, the GUI 300 also includes a group statistics control 340 that, when selected, causes the GUI to display group statistics. For example, in FIG. 3D, a pie chart 350 and a bar graph 352 show statistics about each group. In FIG. 3D, a collapsed dataframe table 322′ is automatically displayed in place of the dataframe table 322, so as to provide more space in the GUI to display the group statistics.

The GUI 300 also includes a results control 344 that, when selected, causes the GUI to display output data of the one or more algorithmic fairness analysis. In some cases, this output data is in the form of a report (e.g., a data file) that is downloaded onto the user device 140. In some other cases, this output data is displayed in the GUI 300.

In FIG. 3C, after the first input 325, the second input 327, and the third input 329 are received by the AMC tool 120, the AMC tool 120 causes the GUI 300 to modify the one or more controls 310 to display several controls for selecting the different types of algorithmic fairness analysis. For example, the one or more controls 310 include a control for a main type of output data, such as data relates to group statistics and the dataframe table corresponding to the input data. The one or more control 310 further include a control for disparate impact analysis, a control for calibration analysis, a control for average predicated score analysis, and a control for performance metrics analysis. For example, after detecting a user selected the control for disparate impact analysis, the AMC tool 120 will cause the output data section 302 in the GUI 300 to display output data for disparate impact analysis.

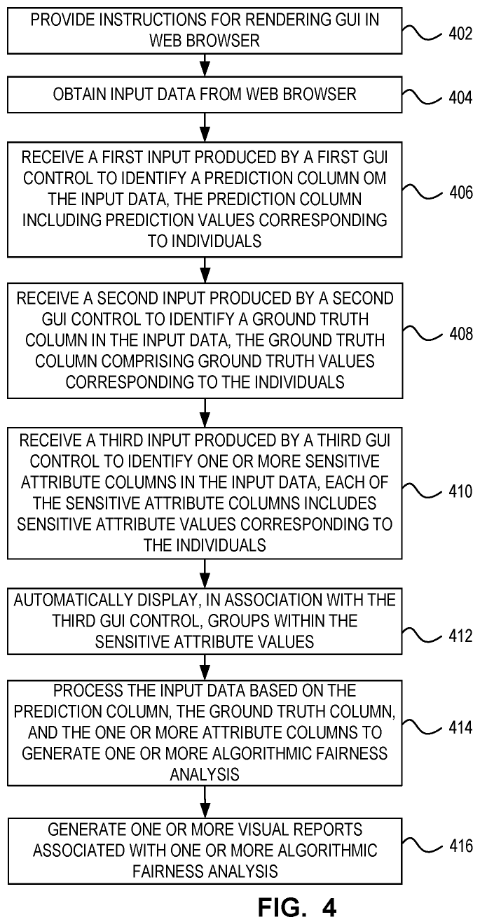

Turning to FIG. 4, an example method is provided for the analytics server 110 to assess AI/ML model fairness. In an example aspect, the operations described in the blocks in the flow diagram are executable instructions that are executed by the one or more processors of the analytics server 110.
Block 402: The analytics server provides instructions for rendering a GUI in a web browser.
Block 404: The analytics server obtains input data from the web browser.
Block 406: The analytics server receives a first input produced by a first GUI control of the GUI to identify a prediction column in the input data, the prediction column comprising a plurality of prediction values corresponding to a plurality of individuals.
Block 408: The analytics server receives a second input produced by a second GUI control of the GUI to identify a ground truth column, the ground truth column comprising a plurality of ground truth values corresponding to the plurality of individuals.
Block 410: The analytics server receives a third input produced by a third GUI control of the GUI to identify one or more sensitive attribute columns, wherein each of the sensitive attribute columns comprises a plurality of sensitive attribute values corresponding to the plurality of individuals.
Block 412: The analytics server automatically displays, via the web browser, in association with the third GUI control, a plurality of groups within the plurality of sensitive attribute values.
Block 414: The analytics server processes the input data based on the prediction column, the ground truth column and the one or more sensitive attribute columns to generate one or more algorithmic fairness analysis.
Block 416: The analytics server then generates one or more visual reports associated with the one or more algorithmic fairness analysis. In some cases, the one or more visual reports are displayed in the GUI. In some cases, the one or more visual reports are outputted as an output data file.

In an alternative system architecture, the AMC tool 120 and the database 130 locally reside on a user device 140, and the method described in FIG. 4 is executed locally on the user device 140.

In an example aspect, the AMC tool 120 is provides a user-friendly interface that is used to measure the algorithmic fairness in AI/ML models. It allows many different types of AI/ML models to be quickly computationally characterized according to one or more different metrics. In some cases, the AMC tool 120 is used in place of existing technical processes and other tools that are disparate, difficult to use, or limited to specific AI/ML models, or a combination thereof.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 1121). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. An apparatus for assessing machine learning model fairness, comprising:
one or more processors configured to:
provide instructions for rendering a graphical user interface (GUI) in a web browser;
obtain input data from the web browser;
receive a first input produced by a first GUI control of the GUI to identify prediction column in the input data, the prediction column comprising a plurality of prediction values corresponding to a plurality of individuals;
receive a second input produced by a second GUI control of the GUI to identify a ground truth column, the ground truth column comprising a plurality of ground truth values corresponding to the plurality of individuals;
receive a third input produced by a third GUI control of the GUI to identify one or more sensitive attribute columns, wherein each of the sensitive attribute columns comprises a plurality of sensitive attribute values corresponding to the plurality of individuals;
automatically display in association with the third GUI control a plurality of groups within the plurality of sensitive attribute values;
process the input data based on the prediction column, the ground truth column and the one or more sensitive attribute columns to generate one or more algorithmic fairness analysis; and
display one or more visual reports associated with the one or more algorithmic fairness analysis.

2. The apparatus of claim 1, wherein the one or more processors are further configured to receive a fourth input produced by a fourth GUI control of the GUI to identify a reference group from the plurality of groups.

3. The apparatus of claim 1, wherein the one or more processors are further configured to receive a merging input produced by the GUI to merge at least two groups in the plurality of groups, and responsive to the merging input, cause the GUI to display a merged group in place of the at least two groups.

4. The apparatus of claim 3, wherein the plurality of groups is displayed in an editable field in the GUI, and the merging input is produced using the editable field.

5. The apparatus of claim 3, wherein the merging input comprises a first bracket and a second bracket inputted around the at least two groups.

6. The apparatus of claim 1, wherein the one or more processors are further configured to receive a fifth input produced by a fifth GUI control to identify a top percentile.

7. The apparatus of claim 1, wherein the one or more processors are further configured to receive a sixth input produced by a sixth GUI control to identify a bottom percentile.

8. The apparatus of claim 1, wherein the one or more algorithmic fairness analysis is selected from the group consisting of: a disparate impact report, a calibration curves report, an average predicted score report, and a performance metrics report.

9. The apparatus of claim 1, wherein the input data is a comma-separated value file.

10. A method for assessing machine learning model fairness, the method executed in a computing environment comprising one or more processors and memory, the method comprising:
providing instructions for rendering a graphical user interface (GUI) in a web browser;
obtaining input data from the web browser;
receiving a first input produced by a first GUI control of the GUI to identify prediction column in the input data, the prediction column comprising a plurality of prediction values corresponding to a plurality of individuals;
receiving a second input produced by a second GUI control of the GUI to identify a ground truth column, the ground truth column comprising a plurality of ground truth values corresponding to the plurality of individuals;
receiving a third input produced by a third GUI control of the GUI to identify one or more sensitive attribute columns, wherein each of the sensitive attribute columns comprises a plurality of sensitive attribute values corresponding to the plurality of individuals;
automatically displaying in association with the third GUI control a plurality of groups within the plurality of sensitive attribute values;
processing the input data based on the prediction column, the ground truth column and the one or more sensitive attribute columns to generate one or more algorithmic fairness analysis; and
displaying one or more visual reports associated with the one or more algorithmic fairness analysis.

11. The method of claim 10, further comprising receiving a fourth input produced by a fourth GUI control of the GUI to identify a reference group from the plurality of groups.

12. The method of claim 10, further comprising receiving a merging input produced by the GUI to merge at least two groups in the plurality of groups, and responsive to the merging input, causing the GUI to display a merged group in place of the at least two groups.

13. The method of claim 12, wherein the plurality of groups is displayed in an editable field in the GUI, and the merging input is produced using the editable field.

14. The method of claim 12, wherein the merging input comprises a first bracket and a second bracket inputted around the at least two groups.

15. The method of claim 10, further comprising receiving a fifth input produced by a fifth GUI control to identify a top percentile.

16. The method of claim 10, further comprising receiving a sixth input produced by a sixth GUI control to identify a bottom percentile.

17. The method of claim 10, wherein the one or more algorithmic fairness analysis is selected from a group consisting of: a disparate impact report, a calibration curves report, an average predicted score report, and a performance metrics report.

18. The method of claim 10, wherein the input data is a comma-separated value file.

19. A non-transitory computer readable medium storing computer executable instructions which, when executed by at least one computer processor, cause the at least one computer processor to carry out a method of assessing machine learning model fairness, the method comprising:
providing instructions for rendering a graphical user interface (GUI) in a web browser;
obtaining input data from the web browser;
receiving a first input produced by a first GUI control of the GUI to identify prediction column in the input data, the prediction column comprising a plurality of prediction values corresponding to a plurality of individuals;
receiving a second input produced by a second GUI control of the GUI to identify a ground truth column, the ground truth column comprising a plurality of ground truth values corresponding to the plurality of individuals;
receiving a third input produced by a third GUI control of the GUI to identify one or more sensitive attribute columns, wherein each of the sensitive attribute columns comprises a plurality of sensitive attribute values corresponding to the plurality of individuals;
automatically displaying in association with the third GUI control a plurality of groups within the plurality of sensitive attribute values;
processing the input data based on the prediction column, the ground truth column and the one or more sensitive attribute columns to generate one or more algorithmic fairness analysis; and
displaying one or more visual reports associated with the one or more algorithmic fairness analysis.
